(19) United States
(12) Patent Application Publication
(10) Pub. No.: US 2024/0145182 A1
(43) Pub. Date: May 2, 2024

(54) METHOD FOR ALIGNING MULTILAYER COMPONENTS AND METHOD FOR MANUFACTURING MULTILAYER CERAMIC ELECTRONIC COMPONENTS

(71) Applicant: KYOCERA Corporation, Kyoto-shi, Kyoto (JP)

(72) Inventor: Hisashi SATO, Kirishima-shi (JP)

(73) Assignee: KYOCERA Corporation, Kyoto-shi, Kyoto (JP)

(21) Appl. No.: 18/279,912

(22) PCT Filed: Mar. 1, 2022
(86) PCT No.: PCT/JP2022/008563

§ 371 Date: Sep. 1, 2023

(30) Foreign Application Priority Data
Mar. 2, 2021 (JP) 2021-032935

(51) Int. Cl. H01G 13/00; H01G 4/30

(52) U.S. Cl. CPC H01G 13/00; H01G 4/30

(57) ABSTRACT

A magnetic field is applied to multiple base components placed in a space between a support and an upper member to align the base components in a same direction. The support contains a nonmagnetic material and includes a support surface being flat and parallel to a horizontal direction. The upper member contains a nonmagnetic material and is located above the support at a predetermined distance from the support surface. The magnetic field includes a magnetic flux line intersecting with the support surface.

### TECHNICAL FIELD

The present disclosure relates to a method for aligning multilayer components and a method for manufacturing multilayer ceramic electronic components.

### BACKGROUND OF INVENTION

A known technique is described in, for example, Patent Literature 1.

### CITATION LIST

### Patent Literature

Patent Literature 1: Japanese Unexamined Patent Application Publication No. 2003-7574

### SUMMARY

In one or more aspects of the present disclosure, a method for aligning multilayer components includes placing a plurality of multilayer components in a space between a support and an upper member, and applying a magnetic field to the plurality of multilayer components to align the plurality of multilayer components in a same direction. Each of the plurality of multilayer components is a rectangular prism including ceramic green sheets and ferromagnetic electrode layers alternately stacked on one another. The support contains a nonmagnetic material and includes a support surface being flat and parallel to a horizontal direction. The upper member contains a nonmagnetic material and is located above the support at a predetermined distance from the support surface. The magnetic field includes a magnetic flux line intersecting with the support surface.

In one or more aspects of the present disclosure, a method for manufacturing multilayer ceramic components includes the aligning method described above, processing surfaces of the plurality of multilayer components aligned in the same direction, and firing the plurality of multilayer components.

### BRIEF DESCRIPTION OF THE DRAWINGS

The objects, features, and advantages of the present disclosure will become more apparent from the following detailed description and the drawings.

FIG. 1 is a perspective view of an example multilayer ceramic capacitor.

FIG. 2 is a diagram of a base component before firing.

FIG. 3 is a perspective view of a precursor of the base component.

FIG. 4 is a schematic enlarged cross-sectional view of the base precursor.

FIG. 5A is a diagram of base components placed on a support.

FIG. 5B is a diagram of base components placed on the support.

FIG. 5C is a schematic diagram describing an alignment method according to an embodiment.

FIG. 5D is a schematic diagram describing the alignment method according to the embodiment.

FIG. 6 is a schematic diagram describing an alignment method according to another embodiment.

FIG. 7 is a schematic diagram of a component assembly being formed.

FIG. 8 is a schematic diagram of the base components being fixed.

FIG. 9 is a schematic diagram describing a method for manufacturing multilayer components.

FIG. 10 is a schematic diagram describing the method for manufacturing the multilayer components.

FIG. 11 is a schematic diagram describing the method for manufacturing the multilayer components.

FIG. 12 is a schematic diagram describing the method for manufacturing the multilayer components.

FIG. 13A is a schematic diagram describing a method for aligning the multilayer components.

FIG. 13B is a schematic diagram describing the method for aligning the multilayer components.

FIG. 13C is a schematic diagram describing the method for aligning the multilayer components.

FIG. 13D is a schematic diagram describing the method for aligning the multilayer components.

FIG. 14 is a schematic diagram describing the method for manufacturing the multilayer components.

FIG. 15 is a schematic diagram describing the method for manufacturing the multilayer components.

FIG. 16 is a schematic diagram describing the method for manufacturing the multilayer components.

FIG. 17 is a schematic diagram describing another method for manufacturing the multilayer components.

FIG. 18 is a schematic diagram describing another method for manufacturing the multilayer components.

FIG. 19 is a schematic diagram describing another method for manufacturing the multilayer components.

FIG. 20A is a schematic diagram describing another method for aligning the multilayer components.

FIG. 20B is a schematic diagram describing another method for aligning the multilayer components.

FIG. 21 is a schematic diagram describing another method for manufacturing the multilayer components.

FIG. 22 is a schematic diagram describing another method for manufacturing the multilayer components.

FIG. 23 is a perspective view of an upper member in another example.

### DESCRIPTION OF EMBODIMENTS

Recent small and highly functional electronic devices incorporate smaller electronic components. Examples of such electronic components include multilayer ceramic capacitors that typically have a size of 1 mm or less on each side.

The manufacturing processes of such multilayer ceramic capacitors include polishing the end faces or side surfaces of base components and forming, for example, protective layers. These processes are preceded by aligning the target surfaces of multiple base components by rotating the base components. For example, substantially rectangular prism-shaped chips including extension electrodes of internal electrodes exposed at edges in the width direction are received in pockets of a recessed pallet. A magnet is then moved along the bottom surface of the pallet from outside to attract and overturn the chips in the pocket, thus aligning the chips in the same direction (refer to Patent Literature 1).

Smaller base components are more difficult to have their target surfaces aligned. For example, the alignment method described in Patent Literature 1 involves placing the chips into the pockets. This process is more complicated for smaller base components.

A method for aligning multilayer components and a method for manufacturing multilayer ceramic components according to one or more embodiments of the present disclosure will now be described with reference to the drawings. A multilayer ceramic capacitor will now be described as an example multilayer ceramic electronic component. However, the multilayer ceramic component to be manufactured in the embodiments of the present disclosure is not limited to the multilayer ceramic capacitor, and may be any of various other multilayer ceramic components such as multilayer piezoelectric elements, multilayer thermistor elements, multilayer chip coils, and multilayer ceramic substrates.

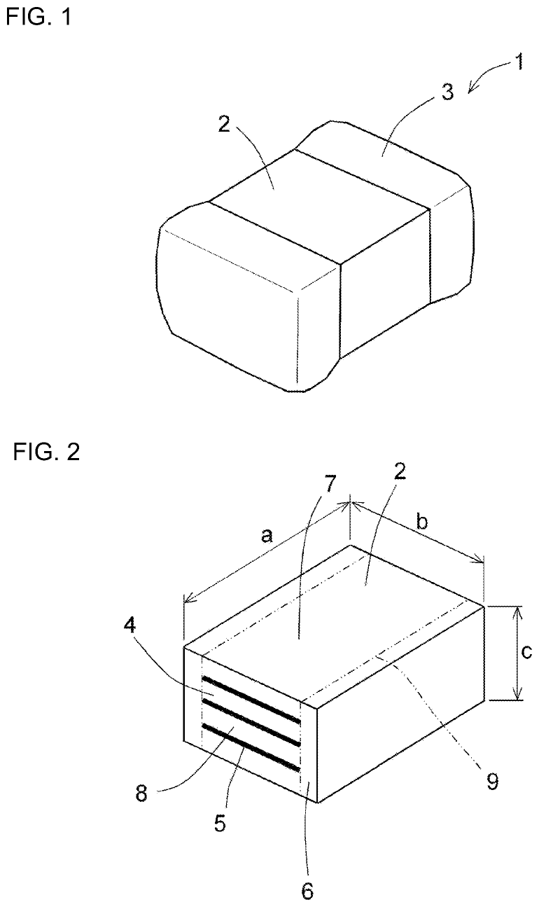

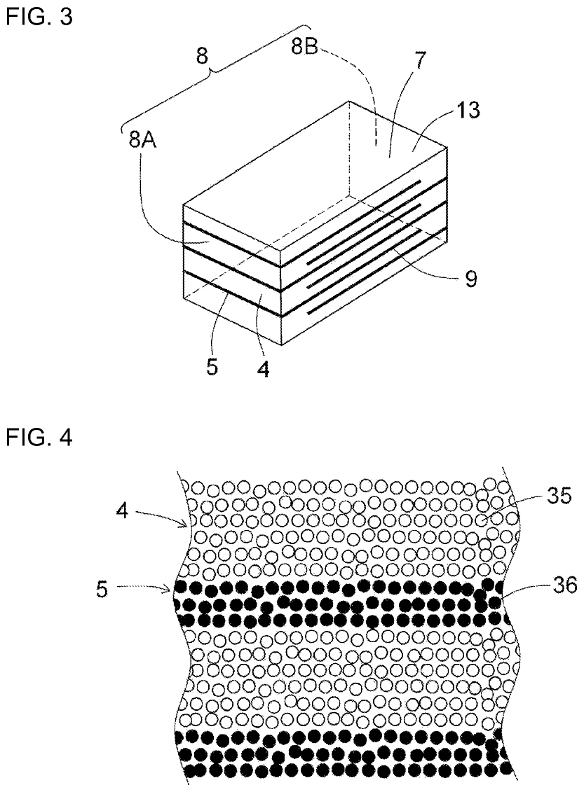

The multilayer ceramic capacitor as an example multilayer ceramic electronic component will first be described. FIG. 1 is a perspective view of an example multilayer ceramic capacitor. FIG. 2 is a schematic perspective view of a base component of the multilayer ceramic capacitor in FIG. 1. FIG. 2 is a diagram of the base component before firing. The base component shrinking after firing has the same structure as before firing. FIG. 2 is thus also a diagram of the base component after firing. FIG. 3 is a perspective view of a precursor of the base component in FIG. 2. The precursor of the base component may be hereafter referred to as a base precursor.

A multilayer ceramic capacitor 1 includes a base component 2 and external electrodes 3. As illustrated in FIG. 2, the base component 2 is substantially a rectangular prism. The base component 2 includes dielectric ceramics 4 and multiple internal electrode layers 5 connected to the external electrodes 3. The external electrodes 3 are located on a pair of end faces of the base component 2 and extend to other adjacent faces. The internal electrode layers 5 extend inward from the pair of end faces of the base component 2 and are alternately stacked without contact with each other. The internal electrode layers 5 are, for example, ferromagnetic layers containing a ferromagnetic metal material.

Each external electrode 3 includes an under layer connecting to the base component 2 and a plated outer layer that facilitates mounting of an external wire to the external electrode 3 by soldering. The under layer may be applied to the base component 2 after firing by thermal treatment. The under layer may be placed on the base component 2 before firing and fired together with the base component 2. The external electrode 3 may include multiple under layers and multiple plated outer layers to have an intended function. The external electrode 3 may include no plated outer layer and may include the under layer and a conductive resin layer.

As illustrated in FIGS. 2 and 3, the base component 2 includes a base precursor 13 and protective layers 6. As illustrated in FIG. 3, the base precursor 13 is substantially a rectangular prism. The base precursor 13 includes surfaces 7 opposite to each other, end faces 8 opposite to each other, and side surfaces 9 opposite to each other. The base component 2 has the dimensional relationship of, for example, a>b>c, where a is the length of each surface 7, b is the width of each surface 7, and c is the thickness of each surface 7 in the stacking direction.

The internal electrode layers 5 are exposed on the end faces 8 and the side surfaces 9 of the base precursor 13. The protective layers 6 are located on the side surfaces 9 of the base precursor 13. The protective layers 6 reduce the likelihood of electrical short-circuiting between the internal electrode layers 5 exposed on a first end face 8A and the internal electrode layers 5 exposed on a second end face 8B. The protective layers 6 also physically protect portions of the internal electrode layers 5 exposed on the side surfaces 9 of the base precursor 13. The protective layers 6 are attached in a final process in manufacturing the base component 2. The protective layers 6 protect the exposed internal electrode layers 5 on the side surfaces 9 of the base precursor 13. The protective layers 6 may be made of a ceramic material. In this case, the protective layers 6 may be insulating and have high mechanical strength. The ceramic material to be the protective layers 6 is normally applied to the base precursor 13 before firing. The boundaries between the base precursor 13 and the protective layers 6 indicated by two-dot-dash lines in FIG. 2 actually appear unclear.

The base precursor 13, which is the precursor of the base component 2, is described above, in addition to the base component 2. The multilayer component in one or more embodiments of the present disclosure includes both the base component 2 and the base precursor 13.

FIG. 4 is a schematic enlarged cross-sectional view of the base precursor. Ceramic green sheets 10 and the internal electrode layers 5 are alternately stacked on one another. Ceramic powder and metal powder are yet to be sintered in firing. The ceramic green sheets 10 thus include dispersed dielectric ceramic particles 35 in an organic binder. Similarly, the internal electrode layers 5 include dispersed nickel particles 36 in an organic binder.

With the method for aligning the multilayer components according to the present embodiment described below, the internal electrode layers 5 are to have high magnetic susceptibility to respond to a magnetic field. The nickel particles 36 in the internal electrode layers 5 are surrounded by the organic binder and are mostly out of contact with each other. To increase the magnetic susceptibility of the internal electrode layers 5, the internal electrode layers 5 have a content of the organic binder being 1.5 times or less, by volume, the content of nickel particles being a ferromagnetic metal material.

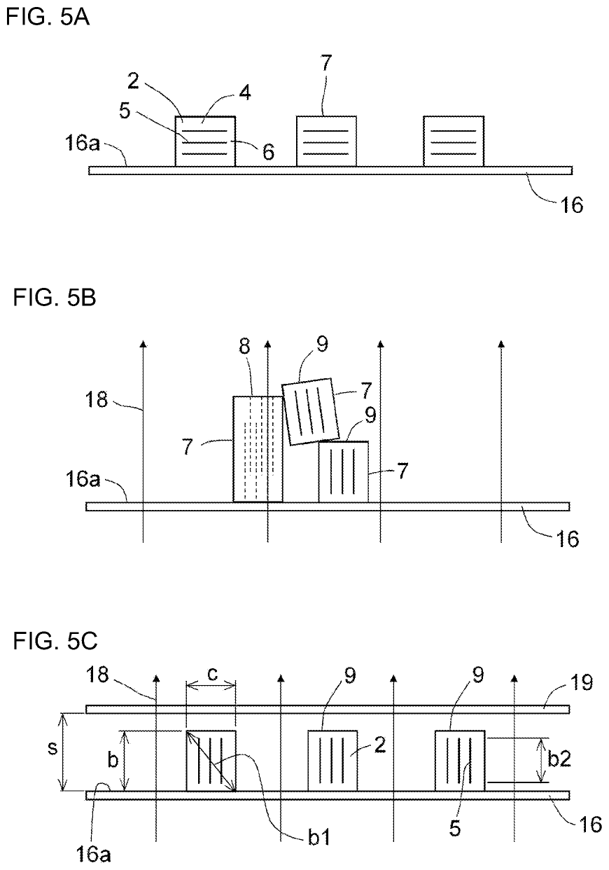

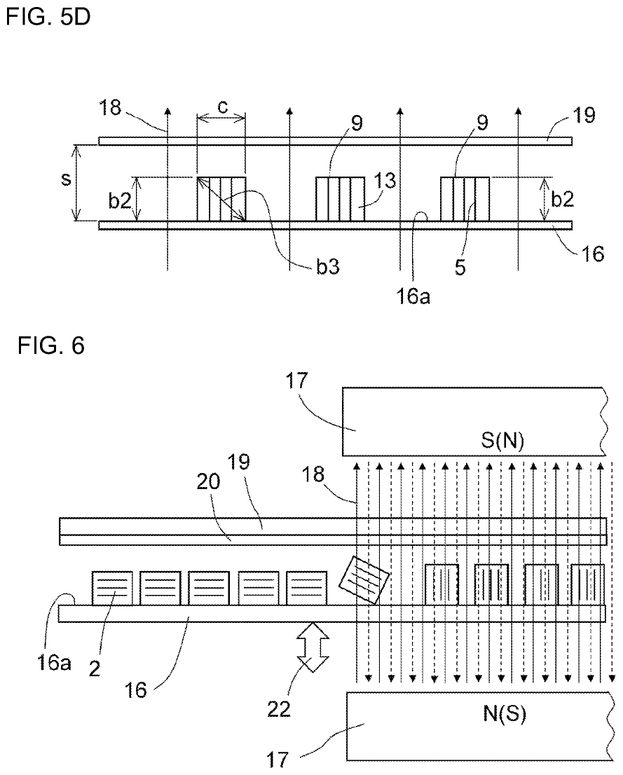

FIGS. 5A and 5B illustrate base components placed on a support. As illustrated in FIG. 5A, although the base components 2 are placed on a support 16 without being aligned intentionally, most of the base components 2 have the largest surfaces 7 parallel to a support surface 16a of the support 16.

As illustrated in FIG. 5B, when a magnetic field having magnetic flux lines 18 intersecting with the support surface 16a is applied to the base components 2 in the state in FIG. 5A, the base components 2 rotate to have the extension directions (directions in which the surfaces extend) of the internal electrode layers 5 in the base components 2 parallel to the magnetic flux lines 18. In other words, the base components 2 rotate to have the thickness direction of the internal electrode layers 5 perpendicular to the magnetic flux lines 18. Each base component 2 thus has either the side surfaces 9 parallel to the support surface 16a (first state) or the end faces 8 parallel to the support surface 16a (second state). The base components 2 typically undergo processes, such as forming the protective layers 6 on their side surfaces 9. All the base components 2 are thus to be aligned in the same direction in the first state. However, as described above, the base components 2 are in either of the two states and may not easily be aligned in the same direction. Moreover, the base components 2 in the first state may be stacked on one another in the vertical direction.

FIGS. 5C and 5D are schematic diagrams describing the alignment method according to the present embodiment. In the present embodiment, as illustrated in FIG. 5C, the base components 2 are placed in a space between a support 16 and an upper member 19. The support 16 is made of a nonmagnetic material and including a flat support surface 16a parallel to the horizontal direction. The upper member 19 is made of a nonmagnetic material and located above the support 16 at a predetermined distance from the support surface 16a. The magnetic field having the magnetic flux lines 18 intersecting with the support surface 16a is applied to the base components 2 to align the base components 2 in the same direction.

In the present embodiment, as illustrated in FIG. 5D, the base precursors 13 are placed in the space between the support 16 and the upper member 19. The magnetic field having the magnetic flux lines 18 intersecting with the support surface 16a is applied to the base precursors 13 to align the base precursors 13 in the same direction.

The support 16 and the upper member 19 may be made of any nonmagnetic material such as a resin material, hard paper, and a ceramic material, or a nonmagnetic metal material such as aluminum. The support 16 and the upper member 19 may be made of any of these nonmagnetic materials that are thick and rigid enough to resist deformation.

The space between the support 16 and the upper member 19 is defined to allow rotation of the base components 2 or the base precursors 13 about an axis extending in the longitudinal direction, or more specifically, a direction perpendicular to the end faces 8. The space is also defined to prevent base components 2 (base precursors 13) in the first state from being stacked on one another in the vertical direction and from being in the second state.

Each end face 8 of the base components 2 has a vertical dimension b, a horizontal dimension c, and a diagonal dimension b1. To align the base components 2 in the same direction, a space s between the support 16 and the upper member 19 may satisfy b1<s<(the smaller one of 2×b or a). When b1<s, the base components 2 are allowed to rotate. When s<(the smaller one of 2×b or a), the base components 2 in the first state can be prevented from being stacked on one another or from being in the second state.

With each internal electrode layer 5 having a width b2, each end face 8 of the base precursors 13 has a vertical dimension b2, a horizontal dimension c, and a diagonal dimension b3. To align the base precursors 13 in the same direction, the space s between the support 16 and the upper member 19 may satisfy b3<s<(the smaller one of 2×b2 or a), where b3 is the diagonal dimension of the end face 8. When b3<s, the base precursors 13 are allowed to rotate. When s<(the smaller one of 2×b2 or a), the base precursors 13 are prevented from being stacked on one another and from being in the second state. The base components 2 including the protective layers 6 can have a sufficient moment for rotation under a magnetic field when the width b2 of each internal electrode layer 5 satisfies 0.75b<b2<b.

FIG. 6 is a schematic diagram describing an alignment method according to another embodiment. As illustrated in the figure, the base components 2 placed in the space between the support 16 and the upper member 19 are moved relatively in the horizontal direction into a pregenerated magnetic field. Being moved relatively herein refers to the base components 2 placed in the space being moved together with the support 16 and the upper member 19 when the magnetic field is fixed, or the pregenerated magnetic field being moved when the base components 2 in the space are fixed with the support 16 and the upper member 19. When the magnetic field is applied to the base components 2 on the support 16, the base components 2 spontaneously rotate with the extension directions of the internal electrode layers 5 parallel to the direction of the magnetic flux lines 18 and are aligned in the same direction.

When the base components 2 placed in the space are moved into the magnetic field in the horizontal direction, the base components 2 under the magnetic field start to rotate sequentially. The base components 2 may rotate in the same direction depending on the direction of the magnetic flux lines 18. When, for example, the base components 2 are moved into a magnetic field having upward or downward magnetic flux lines 18 from the left, the base components 2 in the space start to rotate sequentially from the rightmost base component 2 to the right and are aligned in the same direction. The rotation direction of the base components 2 can thus be controlled.

The base components 2 in the space between the support 16 and the upper member 19 may receive vibration. In the present embodiment, such vibration is applied in, for example, the vertical direction as indicated by arrow 22. In the present embodiment, vibration is applied to the support 16. In the space between the support 16 and the upper member 19, base components 2 at narrow intervals in the horizontal direction may be restricted by adjacent base components 2 from rotating under the magnetic field. The vibration can increase the intervals between the base components 2. Such base components 2 can rotate easily. The upper member 19 may also receive vibration in the same or similar manner to the support 16. The vibration may be applied in the horizontal direction, in addition to the vertical direction, or may be applied in both the horizonal and vertical directions.

The magnetic field to be applied to the base components 2 may be, for example, generated by a magnet (first magnet) 17 located below the support 16 and a magnet (second magnet) 17 located above the upper member 19. The facing surfaces of the two magnets 17 may have opposite polarities to cause the magnetic flux lines 18 of the magnetic field to intersect with the support surface 16a. The magnets 17 may be permanent magnets or electromagnets. Each magnet 17 may be, for example, any magnet with an area larger than the area of the portion of the support surface 16a of the support 16 in which the base components 2 are placed.

The magnetic field may be applied to, for example, the base components 2 continuously, or intermittently with repeated periods in which a magnetic field is applied and is not applied. The intermittent magnetic field can increase the intervals between the base components 2 in the same or similar manner to the vibration applied as described above. For the intermittent magnetic field, the magnets 17 being permanent magnets act when the magnets 17 are close to the support 16 and the upper member 19 and do not act when the magnets 17 are away from the support 16 and the upper member 19. The magnets 17 being electromagnets may be activated while a current is being supplied and may be deactivated while no current is being supplied.

For example, the magnet 17 below the support 16 (first magnet) alone or the magnet 17 above the upper member 19 (second magnet) alone may be used. The upper and lower magnets 17 together may generate a uniform magnetic field in a wide area. This allows the base components 2 at any position on the support surface 16a to rotate and align in the same direction.

The magnetic field may have the direction of the magnetic flux lines 18 (direction of the magnetic field) reversed repeatedly. The ferromagnetic internal electrode layers 5 in the base components 2 are magnetized under a magnetic field, and may have residual magnetism. The residual magnetism may complicate the handling of the base components 2 in subsequent processes. Reversing the direction of the magnetic flux lines 18 repeatedly causes repeated magnetization and demagnetization, thus reducing the residual magnetism of the internal electrode layers 5.

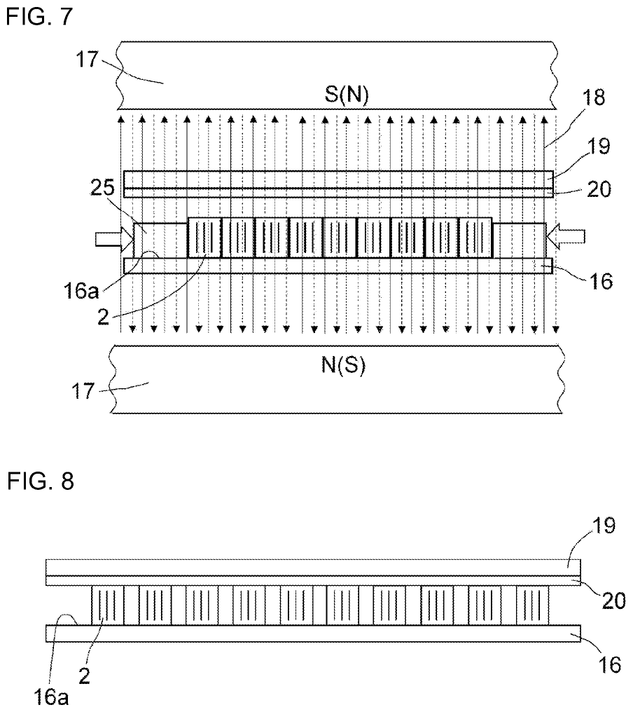

FIG. 7 is a schematic diagram of a component assembly being formed. The base components 2 in the space between the support 16 and the upper member 19 aligned in the same direction as described above are assembled into a component assembly under the magnetic field. For example, fixtures 25 are horizontally moved toward the middle from outside the space in the lateral direction. The base components 2 held between the fixtures 25 on both sides are assembled in the middle. The component assembly can be handled integrally in subsequent processes. The multiple base components 2 can thus be processed at a time. The base components 2 can be processed together faster than when being processed individually. The base components 2 can also be processed under the same conditions.

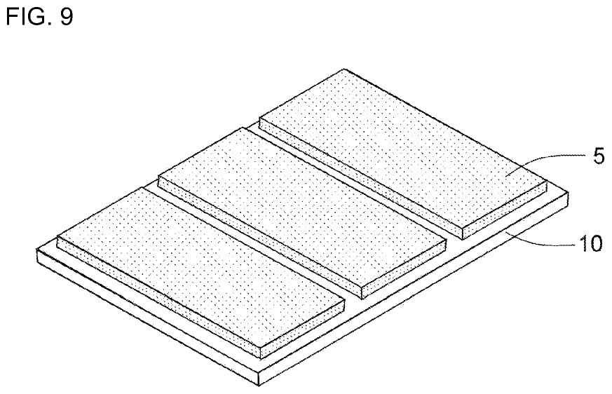

FIG. 8 is a schematic diagram of the base components being fixed. With the base components 2 in the space between the support 16 and the upper member 19 aligned in the same direction as described above, the support 16 and the upper member 19 are placed closer to each other under the magnetic field until holding the aligned base components 2 between the support 16 and the upper member 19. The magnetic field is then stopped. When the magnetic field is stopped with the space left between the support 16 and the upper member 19, the base components 2 may rotate due to the disturbance in the magnetic field stopped or in subsequent handling, possibly causing the base components 2 to be misaligned. The base components 2 held between the support 16 and the upper member 19 are fixed before the magnetic field is stopped and thus are less likely to rotate when the magnetic field is stopped.

The base components 2 held between the support 16 and the upper member 19 are in contact with the support 16 and the upper member 19. To prevent the base components 2 under any impact from being damaged, a portion of the upper member 19 facing the support surface 16a may contain an elastic material. For example, an elastic sheet 20 may be attached to the upper member 19. Another elastic sheet 20 may be attached to the support 16. The elastic sheet 20 may be made of a material having high durability and resistance to abrasion, for example, silicone rubber or urethane rubber.

The method for manufacturing the base components 2 in FIG. 2 and the multilayer ceramic capacitors 1 will now be described. The manufacturing method includes the alignment method described above.

A ceramic mixture powder containing a ceramic dielectric material of BaTiO₃ with an additive is first wet-milled and blended using a bead mill. A polyvinyl butyral binder, a plasticizer, and an organic solvent are added to this milled and blended slurry and are mixed together to prepare ceramic slurry.

A die coater is then used to form a ceramic green sheet 10 on a carrier film. The ceramic green sheet 10 may have a thickness of, for example, about 1 to 10 μm. A thinner ceramic green sheet 10 can increase the capacitance of the multilayer ceramic capacitor. The ceramic green sheet 10 may be shaped with, for example, a doctor blade coater or a gravure coater, rather than with the die coater.

As illustrated in FIG. 9, a conductive paste containing nickel (Ni) made of a ferromagnetic metal material, which is to be the internal electrode layers 5, is printed in a predetermined pattern by screen printing on the prepared ceramic green sheet 10. The conductive paste may be printed by, for example, gravure printing, rather than by screen printing. The conductive paste may contain a metal such as Pd, Cu, or Ag or an alloy of these metals other than Ni. The figure illustrates example internal electrode layers 5 in strip patterns in multiple rows. In some embodiments, the internal electrode layers 5 may be in, for example, an individual electrode pattern.

After printing, the conductive paste is then dried. The solvent content is mainly volatilized by drying. The dried internal electrode layers 5 can contain nickel particles dispersed in an organic binder. Thinner internal electrode layers 5 that allow the capacitor to function can reduce internal defects resulting from internal stress. For a capacitor with a stack of many layers, the internal electrode layers 5 may each have, for example, a thickness of 2.0 μm or less.

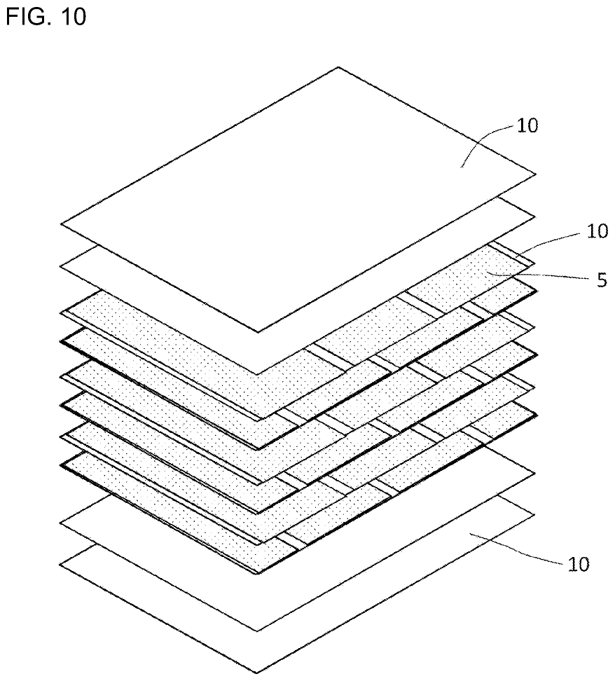

As illustrated in FIG. 10, a predetermined number of ceramic green sheets 10 with printed internal electrode layers 5 are stacked on a stack of a predetermined number of ceramic green sheets 10, and a predetermined number of ceramic green sheets 10 are stacked on the stack of ceramic green sheets 10 with printed internal electrode layers 5. The predetermined number of ceramic green sheets 10 with the printed internal electrode layers 5 are stacked to have the patterns of the internal electrode layers 5 deviating from each other. Although not illustrated in FIG. 10, the ceramic green sheets 10 are stacked on a support sheet. The support sheet may be an adhesive releasable sheet that is adhesive and releasable, such as a low-tack sheet or a foam releasable sheet.

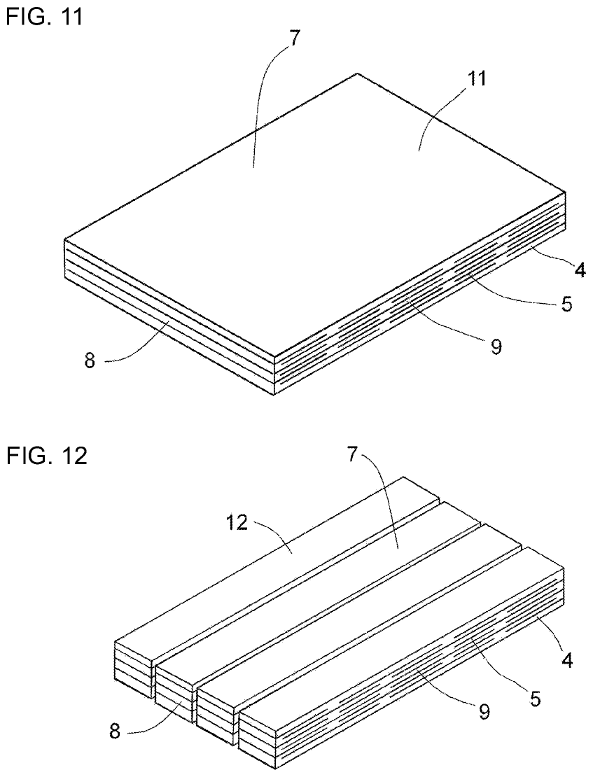

The stack of multiple layers of the ceramic green sheets 10 is then pressed in the stacking direction to obtain an integrated multilayer base 11 as illustrated in FIG. 11. The stack may be pressed using, for example, a hydrostatic press device. In the multilayer base 11, the internal electrode layers 5 are buried in layers between the ceramic green sheets 10. The multilayer base 11 is cut vertically and horizontally to be the base precursors 13 illustrated in FIG. 3. The surfaces, the end faces, and the side surfaces of the multilayer base 11, corresponding respectively to the surfaces 7, the end faces 8, and the side surfaces 9 of the base precursor 13, are hereafter denoted with the same reference signs. Although not illustrated in FIG. 11, the support sheet, which is used in stacking the ceramic green sheets 10, is located under the multilayer base 11.

Subsequently, as illustrated in FIG. 12, the multilayer base 11 is cut into multiple first rods 12 with predetermined dimensions using a press-cutting device. Each first rod 12 includes the cutting surfaces corresponding to the side surfaces 9 of the base precursor 13. The internal electrode layers 5 are exposed on the cutting surfaces of the first rod 12. The multilayer base 11 may be cut with any device other than a press-cutting device. For example, the multilayer base 11 may be cut with a dicing saw. Each internal electrode layer 5 includes discontinuous portions at multiple positions in the longitudinal direction of the first rod 12. In this structure, the internal electrode layers 5 have low apparent magnetic susceptibility in the longitudinal direction in a magnetic field. The first rods 12 thus easily rotate about their axes extending in the longitudinal direction. The discontinuous portions of the internal electrode layers 5 each have a dimension of, for example, 40 μm or more.

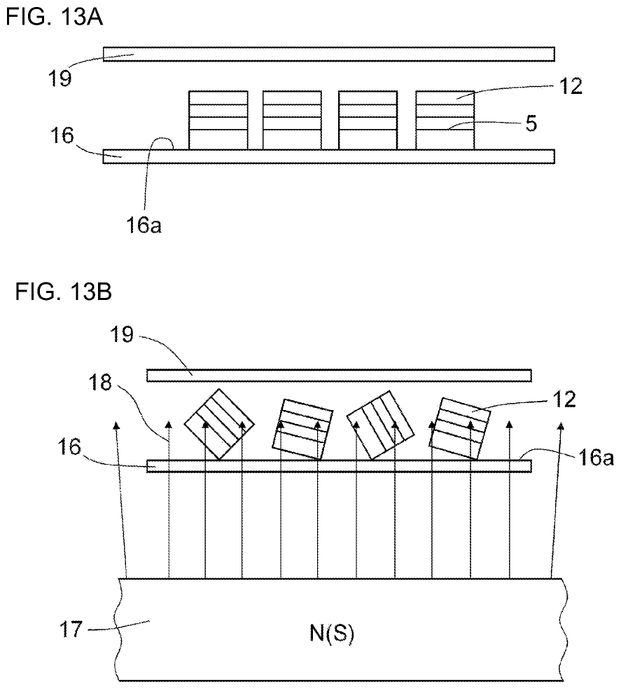

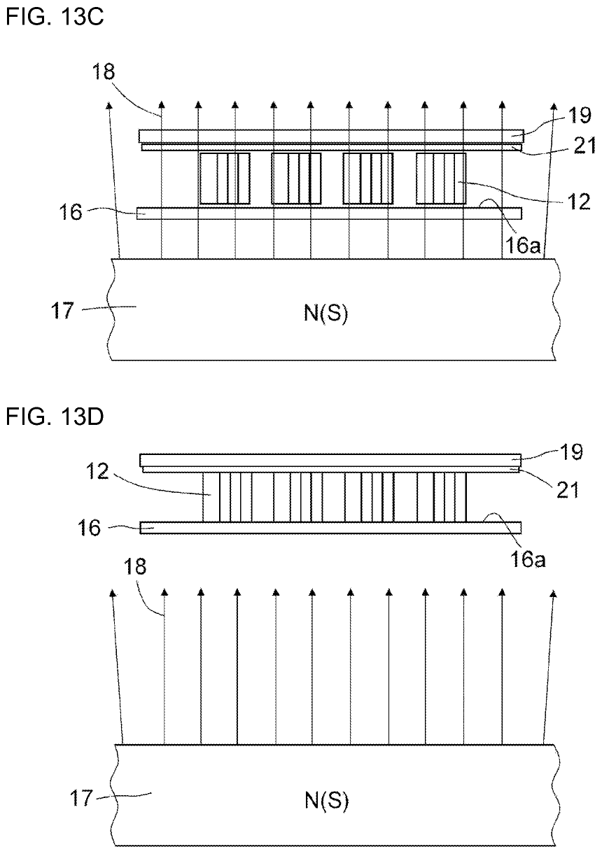

A method for aligning the first rods 12 in the same direction as multilayer components will be described. As illustrated in FIG. 13A, the first rods 12 resulting from cutting are first arranged on the support surface 16a of the support 16. The upper member 19 is then positioned. The first rods 12 are arranged to have their longitudinal directions parallel to each other. The space s between the support 16 and the upper member 19 is, for example, 1.1 times the diagonal dimension b3 of the end faces 8 of the first rods 12. As illustrated in FIG. 13B, the support 16 and the upper member 19 are moved toward the prepositioned magnet 17 to cause the magnet 17 to be below the support 16. The magnet 17 is an electromagnet. When a permanent magnet with N and S poles on opposite surfaces is used, the magnetic force is adjusted based on the distance from the magnet surface. The first rods 12 under the magnetic field generated by the magnet 17 each rotate about an axis extending in the longitudinal direction through the center of the end faces 8. When all the first rods 12 are under the magnetic field, all the first rods 12 are aligned in a direction in which the extension directions of the internal electrode layers 5 are parallel to the magnetic flux lines 18. The aligned first rods 12 are then held and fixed between the upper member 19 and the support 16.

The magnetic field applied to the first rods 12 as multilayer components may be controlled based on, for example, the type of the magnet used and the distance between the multilayer components and the magnet. For example, for a multilayer component including 400 internal electrode layers 5 having a thickness c of 0.63 mm in the stacking direction and an end face width b2 of 1.33 mm, the magnetic flux density is set to 50 gauss or higher by selecting the type of the magnet and the distance from the magnet.

For the first rods 12 held and fixed between the upper member 19 and the support 16, the magnetic field applied to the first rods 12 is stopped. For example, supply of a current to the magnet 17 being an electromagnet may be stopped. As illustrated in FIG. 13C, an adhesive support sheet 21 may be attached, after alignment of the first rods 12, to the upper member 19, or the upper member 19 may be replaced with another upper member 19 with a pre-attached adhesive support sheet 21 to place, from above, the upper member 19 with the support sheet 21 into contact with the aligned first rods 12 under the magnetic field. As illustrated in FIG. 13D, the magnetic field applied to the first rods 12 may be stopped by moving the first rods 12 held between the upper member 19 and the support 16 away from the magnet 17. The multiple first rods 12 fixed to the support sheet 21 are movable after being aligned in the same direction.

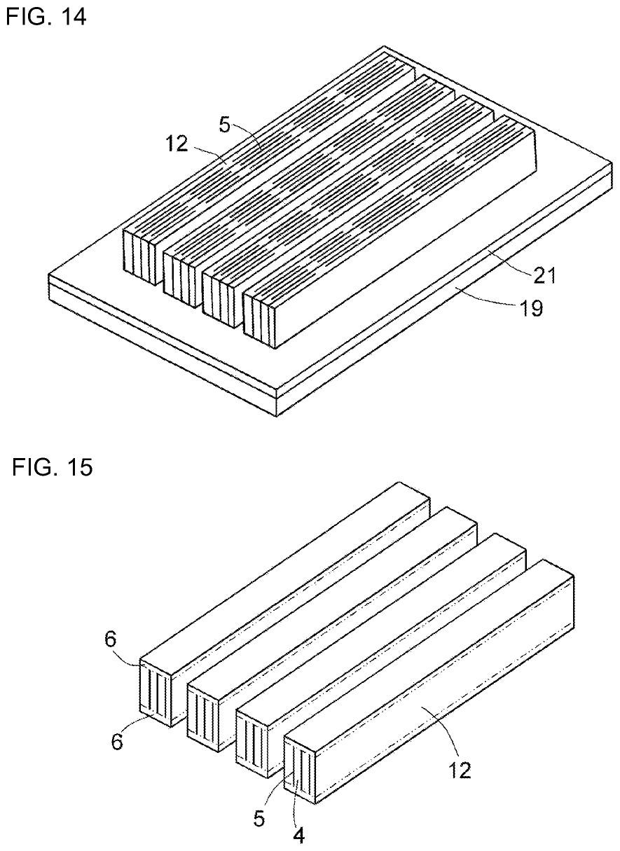

As illustrated in FIG. 14, when the upper member 19 is inverted upside down, the side surfaces 9 of the first rods 12 face upward for the side surfaces 9 to be processed at a time in subsequent processes.

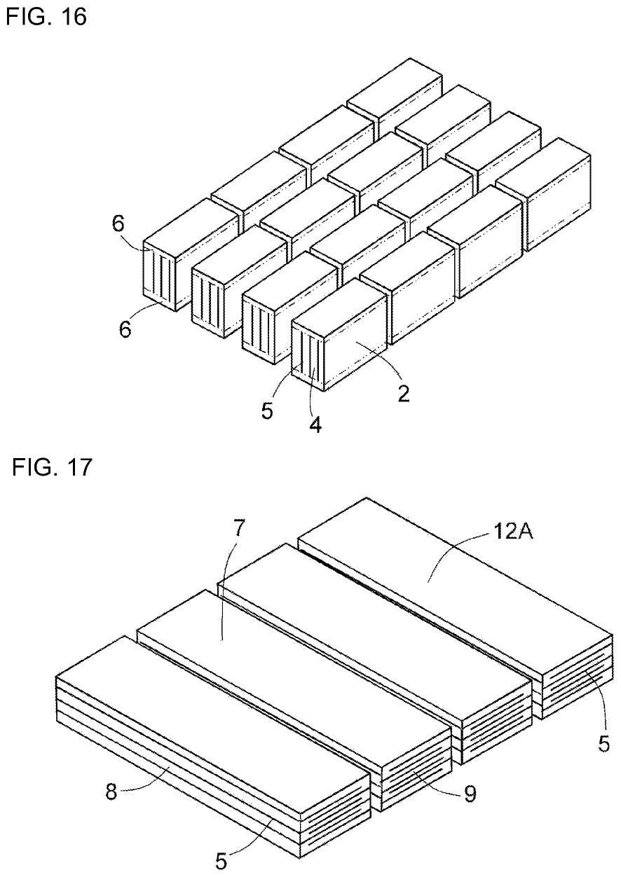

FIG. 15 is a perspective view of the processed first rods. The processes include forming the protective layers 6. With the side surfaces 9 of the first rods 12 aligned in the same direction, ceramic slurry is applied to the side surfaces 9 at a time. After drying, the side surfaces 9 to which the ceramic slurry is applied are fixed to another support sheet 21. The previous support sheet 21 is then released. The ceramic slurry is also applied to the side surfaces 9 newly exposed after the previous support sheet 21 is released. The protective layers 6 are formed by applying the ceramic slurry to the side surfaces 9 in this manner. The applied ceramic slurry may have the same component as the ceramic green sheets 10 in the multilayer base 11. After the protective layers 6 are formed, each of the first rods 12 is cut into the base components 2 as illustrated in FIG. 16. The base components 2 are then fired. The external electrodes 3 are formed to complete the multilayer ceramic capacitors 1. The firing temperature may be set as appropriate based on, for example, the dielectric ceramic material and the metal material contained in the conductive paste to be the internal electrode layers 5. The firing temperature may be, for example, 1100 to 1250° C.

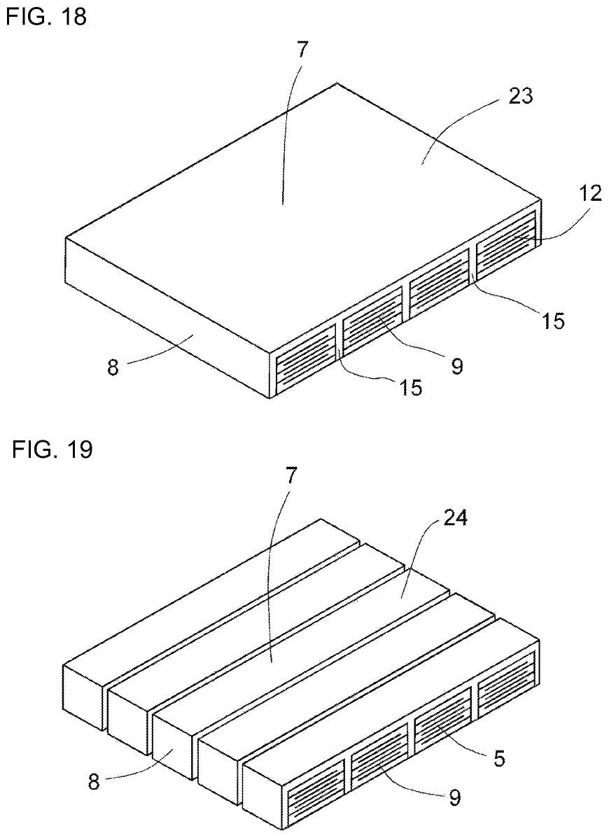

Another manufacturing method will now be described. The method for manufacturing the multilayer base 11 is the same as the method described above, and thus will not be described. As illustrated in FIG. 17, the multilayer base 11 is cut into predetermined dimensions to obtain multiple second rods 12A. The direction of cutting differs by 90° from the direction for cutting the first rods 12 described above. The cutting surfaces of the second rods 12A correspond to the end faces 8 of the base precursors 13. As illustrated in FIG. 18, the gaps between the second rods 12A resulting from cutting are filled with a thermoplastic resin 15, and the surfaces (faces) of the second rods 12A are then coated with the thermoplastic resin 15 to obtain a flat block 23. The flat block 23 is cut into third rods 24, as illustrated in FIG. 19. The direction of cutting differs by 90° from the direction for cutting the second rods 12A, and is the same as the direction for cutting the first rods 12. The cutting surfaces of the third rods 24 correspond to the side surfaces 9 of the base precursors 13. Each third rod 24 includes the base precursors 13 connected together with the thermoplastic resin 15. In the longitudinal direction of the third rods 24, each internal electrode layer 5 includes discontinuous portions separated at multiple positions by the thermoplastic resin 15. In this structure, the internal electrode layers 5 do not have high apparent magnetic susceptibility in the longitudinal direction in a magnetic field. The third rods 24 thus easily rotate about their longitudinal axes. The discontinuous portions of the internal electrode layers 5 each have a dimension of, for example, 40 μm or more.

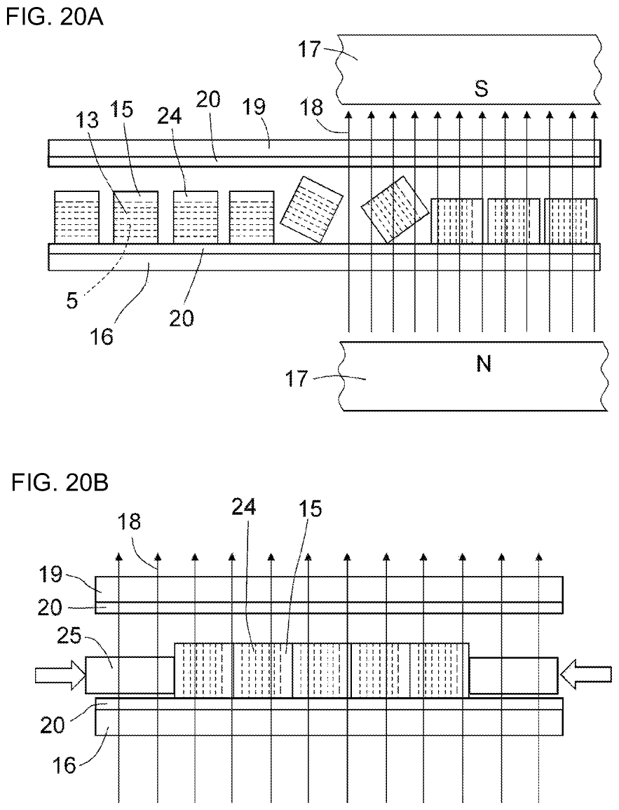

A method for aligning the third rods 24 in the same direction as multilayer components will be described. The third rods 24 resulting from cutting are first arranged on the support surface 16a of the support 16. The upper member 19 is then positioned. The third rods 24 are arranged to have their longitudinal directions parallel to each other. The support 16 and the upper member 19 both have an elastic sheet 20 attached to them. As illustrated in FIG. 20A, two magnets 17 are first positioned. The base components 2 placed in the space between the support 16 and the upper member 19 are moved horizontally, between the two magnets 17, into a pregenerated magnetic field to move in a direction at 90° with respect to the longitudinal direction of the third rods 24. The third rods 24 spontaneously rotate to have the extension direction of the internal electrode layers 5 parallel to the direction of the magnetic flux lines 18 and align in the same direction.

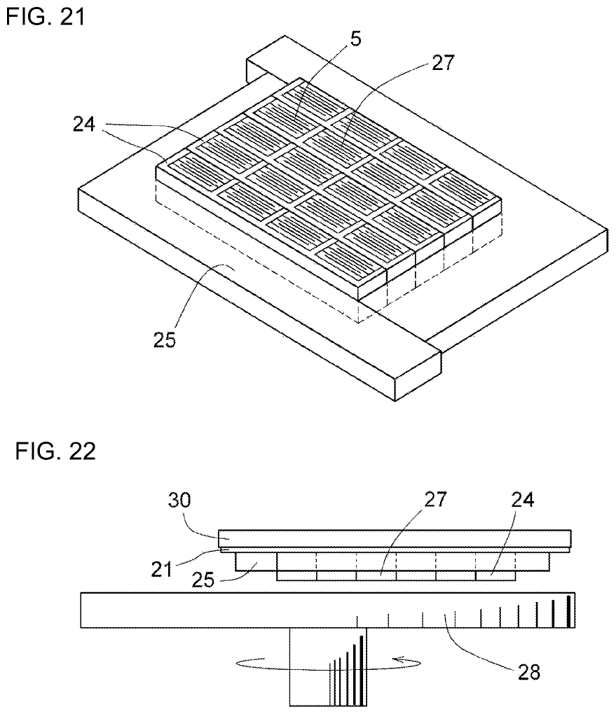

As illustrated in FIG. 20B, the aligned third rods 24 are assembled into a component assembly 27 under the magnetic field. For example, fixtures 25 are horizontally moved toward the middle from outside the space in the lateral direction. In the perspective view in FIG. 21, the fixtures 25 are L-shaped frames. The third rods 24 are positioned in the longitudinal direction and a direction perpendicular to the longitudinal direction by the two fixtures 25 to be a flat component assembly 27.

After the component assembly 27 are formed, the component assembly 27 and the fixtures 25 are fixed to the support sheet 21 on the upper member 19. The side surfaces 9 of the base precursor 13 are exposed on the surface of the component assembly 27 opposite to the surface fixed to the support sheet 21.

FIG. 22 is a schematic diagram of the component assembly being processed. The processes include polishing the side surfaces 9. An abrasive disc 28 may be used to polish the exposed side surfaces 9 of the component assembly 27 fixed to the support sheet 21. The polishing is performed with multiple grinding wheels and abrasive powder, proceeding from coarse to fine grit size. For final polishing, abrasive grains with the mean grain size of 1 μm or less or 0.5 μm or less may be used. The abrasive material may be diamond abrasive grains that have high abrasiveness and are less likely to react with a dielectric material or the material for the electrodes during firing.

After the exposed side surfaces 9 of the component assembly 27 are polished, the polished side surfaces 9 are fixed to another support sheet 21. The previous support sheet 21 is then released. The side surfaces 9 of the component assembly 27 newly exposed after the previous support sheet 21 is released may also be polished.

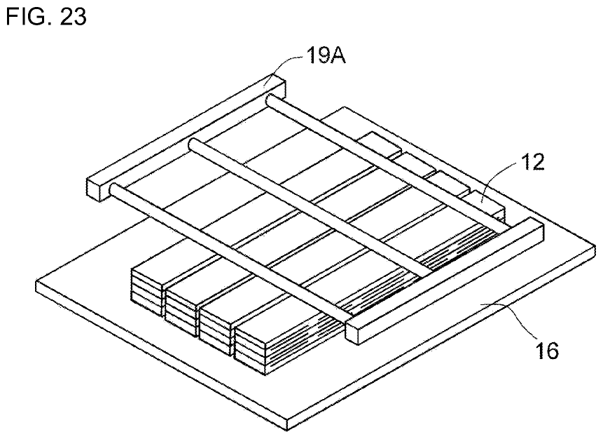

FIG. 23 is a perspective view of an upper member in another example. In the example described above, the upper member 19 is the same or similar plate-like member to the support 16. As described above, the upper member 19 may be, for example, any member that prevents the multilayer components from standing vertically or being stacked on one another, and may be a mesh or a vertical grid. An upper member 19A illustrated in the figure is a vertical grid. The upper member 19A being the vertical grid may be placed with the vertical grid nonparallel to the longitudinal direction of the multilayer components.

The present disclosure may be implemented in the following forms.

In one or more embodiments of the present disclosure, a method for aligning multilayer components includes placing a plurality of multilayer components in a space between a support and an upper member, and applying a magnetic field to the plurality of multilayer components to align the plurality of multilayer components in a same direction. Each of the plurality of multilayer components is a rectangular prism including ceramic green sheets and ferromagnetic electrode layers alternately stacked on one another. The support contains a nonmagnetic material and includes a support surface being flat and parallel to a horizontal direction. The upper member contains a nonmagnetic material and is located above the support at a predetermined distance from the support surface. The magnetic field includes a magnetic flux line intersecting with the support surface.

In one or more embodiments of the present disclosure, a method for manufacturing multilayer ceramic components includes the aligning method described above, processing surfaces of the plurality of multilayer components aligned in the same direction, and firing the plurality of multilayer components.

In one or more embodiments of the present disclosure, the method for aligning the multilayer components can align the multilayer components in the same direction easily and promptly by simply placing the multiplayer components on a flat support surface.

In one or more embodiments of the present disclosure, the method for manufacturing the multilayer ceramic components allows manufacture of the multilayer ceramic components easily and promptly.

The methods, devices, and materials in the embodiments described above are not limited to those described in the embodiments, and may be combined with one another. For example, the ceramic green sheet or the flat bar assembly with ceramic slurry to be the protective layer may be cut before firing, or the flat bar assembly may be polished and then cleaned. Changing the processing conditions in the embodiments or adding new processes to the embodiments as above does not affect the spirit and scope of the present disclosure.

### REFERENCE SIGNS

1 multilayer ceramic capacitor
2 base component
3 external electrode
4 dielectric ceramic
5 internal electrode layer
6 protective layer
7 surface
8 end face
8A first end face
8B second end face
9 side surface
10 ceramic green sheet
11 multilayer base
12 first rod
12A second rod
13 base precursor
15 thermoplastic resin
16 support
16a support surface
17 magnet
18 magnetic flux line
19, 19A upper member
20 elastic sheet
21 support sheet
22 arrow
23 flat block
24 third rod
25 fixture
27 component assembly
28 abrasive disc
35 dielectric ceramic particle
36 nickel particle

1. A method for aligning multilayer components, the method comprising:
placing a plurality of multilayer components in a space between a support and an upper member, each of the plurality of multilayer components being a rectangular prism including ceramic green sheets and ferromagnetic layers alternately stacked on one another, the support comprising a nonmagnetic material and including a support surface being flat and parallel to a horizontal direction, the upper member comprising a nonmagnetic material and being located above the support at a predetermined distance from the support surface; and
applying a magnetic field to the plurality of multilayer components to align the plurality of multilayer components in a same direction, the magnetic field including a magnetic flux line intersecting with the support surface.

2. The method according to claim 1, further comprising:
applying vibration to the plurality of multilayer components placed in the space.

3. The method according to claim 1, wherein
the magnetic field is intermittent.

4. The method according to claim 1, wherein
the magnetic field has a direction of the magnetic flux line reversed repeatedly.

5. The method according to claim 1, wherein
the magnetic field is generated by a first magnet located below the support and a second magnet located above the upper member.

6. The method according to claim 1, wherein
applying the magnetic field includes moving the plurality of multilayer components placed in the space into a pregenerated magnetic field.

7. The method according to claim 1, further comprising:
assembling, with the magnetic field being applied to the plurality of multilayer components, the plurality of multilayer components aligned in the same direction in the space to form a component assembly.

8. The method according to claim 1, further comprising:
stopping applying the magnetic field, with the plurality of multilayer components aligned in the same direction being held between the support and the upper member.

9. The method according to claim 1, wherein
a portion of the upper member facing the support surface comprises an elastic material.

10. The method according to claim 1, wherein
the upper member is a mesh or a vertical grid.

11. The method according to claim 1, wherein
the ferromagnetic layers comprise a ferromagnetic metal material and an organic binder, and have a content of the organic binder being 1.5 times or less a content of the ferromagnetic metal material by volume.

12. The method according to claim 1, wherein
the ferromagnetic layers include discontinuous portions in a longitudinal direction of the plurality of multilayer components.

13. A method for manufacturing multilayer ceramic components, the method comprising:
the method according to claim 1;
processing surfaces of the plurality of multilayer components aligned in the same direction; and
firing the plurality of multilayer components.
